(19) United States
(12) Patent Application Publication
(10) Pub. No.: US 2026/0112171 A1
(43) Pub. Date: Apr. 23, 2026

(54) SYSTEM

(71) Applicant: SoftBank Group Corp., Tokyo (JP)

(72) Inventor: Toshihide DOI, Tokyo (JP)

(21) Appl. No.: 19/355,078

(22) Filed: Oct. 10, 2025

(30) Foreign Application Priority Data
Oct. 18, 2024 (JP) 2024-183670

(51) Int. Cl. G06V 20/52; G06V 10/25; G06V 10/26; G06V 40/10; G06V 40/20

(52) U.S. Cl. CPC G06V 20/52; G06V 10/25; G06V 10/26; G06V 40/10; G06V 40/20

(57) ABSTRACT

The system according to the embodiment includes a collection unit, a detection unit, a cropping unit, and a report generation unit. The collection unit collects video footage from security cameras. The detection unit analyzes the video footage collected by the collection unit and detects suspicious persons. The cropping unit crops only the necessary portions based on the suspicious persons detected by the detection unit. The report generation unit generates a report based on the video cropped by the cropping unit.

### CROSS-REFERENCE TO RELATED APPLICATION

The present application claims priority to and incorporates by reference the entire contents of Japanese Patent Application No. 2024-183670 filed in Japan on Oct. 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that the video footage from security cameras is enormous, making it difficult to efficiently detect suspicious persons and extract only the necessary portions.

### SUMMARY OF THE INVENTION

The system according to embodiments includes a collection unit, a detection unit, a cropping unit, and a report generation unit. The collection unit collects video footage from security cameras. The detection unit analyzes the video footage collected by the collection unit and detects suspicious persons. The cropping unit crops only the necessary portions based on the suspicious persons detected by the detection unit. The report generation unit generates a report based on the video cropped by the cropping unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

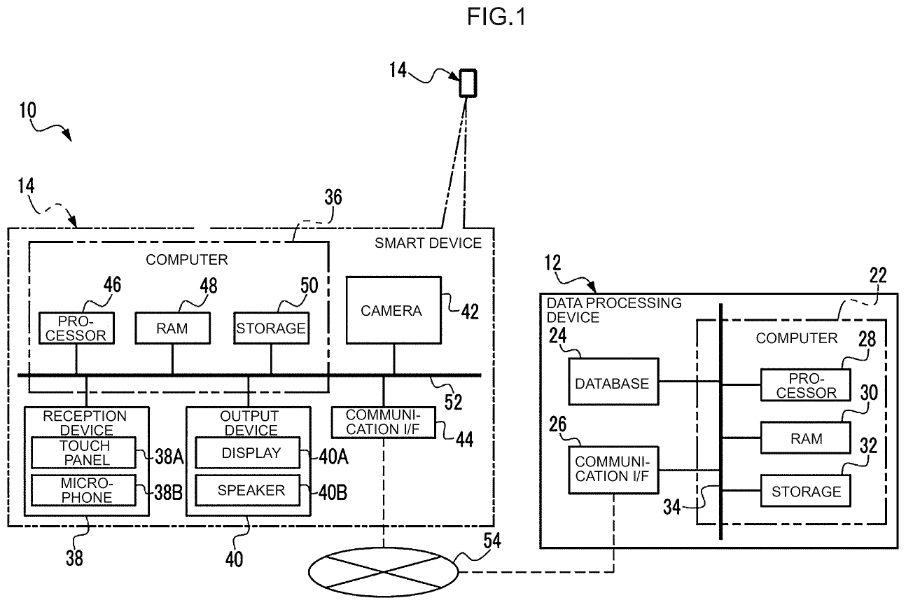

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

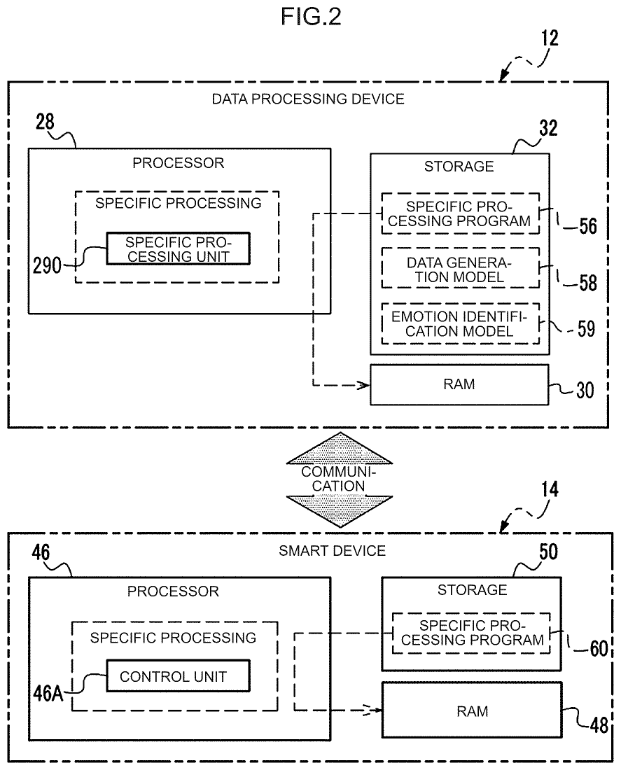

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The shoplifting G-Men AI according to the embodiment of the present invention is a security system for supermarkets and convenience stores. This security system reads video from multiple security cameras and provides the following functions. First, it detects suspicious persons and notifies the staff. The AI analyzes video footage from security cameras and identifies persons exhibiting abnormal behavior. For example, it detects behaviors such as picking up a product and immediately putting it back, or walking around the store unnaturally. This enables early detection of persons who may be shoplifting and notifies the staff. Next, it crops only the necessary portions from the vast amount of video and generates small-sized video files. The AI analyzes video footage from security cameras and extracts only portions that include moments of shoplifting or suspicious behavior. This allows only the necessary portions to be efficiently stored as evidence and reduces data storage requirements. Furthermore, it generates a report for suspect identification. The AI records the actions of detected suspicious persons in detail and compiles them into a report. For example, it describes what actions were taken, at what time, and in which location. This makes it easier to identify the perpetrator and enables smooth reporting to the police and submission of evidence. In this way, the shoplifting G-Men AI aims to eliminate shoplifting damage through detection of suspicious persons, cropping of necessary video, and report generation for suspect identification. As a result, the shoplifting G-Men AI enables efficient collection, analysis, cropping, and report generation of security camera footage.

The shoplifting G-Men AI according to the embodiment includes a collection unit, a detection unit, a cropping unit, and a report generation unit. The collection unit collects video footage from security cameras. For example, the collection unit can collect video from multiple security cameras. The collection unit can use cameras that cover the entire area of the store or cameras that focus on specific areas. The collection unit can also use AI to efficiently collect video footage from security cameras. The detection unit analyzes the video footage collected by the collection unit and detects suspicious persons. For example, the detection unit can use AI to analyze video footage from security cameras and identify persons exhibiting abnormal behavior. The detection unit can detect behaviors such as picking up a product and immediately putting it back, or walking around the store unnaturally. The detection unit can use AI to quickly detect persons exhibiting abnormal behavior and notify the staff. The cropping unit crops only the necessary portions based on the suspicious persons detected by the detection unit. For example, the cropping unit can use AI to analyze video footage from security cameras and extract only portions that include moments of shoplifting or suspicious behavior. The cropping unit can efficiently store only the necessary portions as evidence and reduce data storage requirements. The report generation unit generates a report based on the video cropped by the cropping unit. For example, the report generation unit can use AI to record the actions of detected suspicious persons in detail and compile them into a report. The report generation unit can describe what actions were taken, at what time, and in which location. As a result, the shoplifting G-Men AI according to the embodiment enables efficient collection, analysis, cropping, and report generation of security camera footage.

The collection unit collects video footage from security cameras. For example, the collection unit can collect video from multiple security cameras. Specifically, cameras that cover the entire area of the store or cameras that focus on specific areas can be used. This enables thorough monitoring of every corner of the store and reduces the risk of shoplifting. The collection unit can use AI to efficiently collect video footage from security cameras. The AI automatically adjusts the quality and resolution of the video and collects data in an optimal state. For example, it can correct distortions in the video caused by changes in lighting or camera position and obtain clear footage. In addition, the collection unit collects video in real time and transmits it to a central database. This ensures that the latest footage is always stored and can be used for subsequent analysis and detection. Furthermore, the collection unit can use video data compression technology to efficiently manage data storage. This enables long-term storage of large amounts of video data and allows for retrospective review of past footage. The collection unit can also cooperate with other systems or departments to share data as needed. For example, by cooperating with the police or security companies and providing the collected video data, prompt response becomes possible. In this way, the collection unit can efficiently and effectively collect video footage from security cameras and improve the overall performance of the system.

The detection unit analyzes the video footage collected by the collection unit and detects suspicious persons. The detection unit uses AI to analyze video footage from security cameras and identify persons exhibiting abnormal behavior. Specifically, it can detect behaviors such as picking up a product and immediately putting it back, or walking around the store unnaturally. The AI tracks the movements of persons in the video and detects abnormalities by comparing them with normal behavior patterns. For example, the AI analyzes the speed and direction of movement, length of stay, etc., and identifies behavior that differs from the norm. In addition, the AI learns from past data and models typical shoplifting behavior patterns, enabling more accurate detection. The detection unit can quickly detect persons exhibiting abnormal behavior and notify the staff. Notifications are made in real time, allowing staff to respond immediately. For example, alerts can be sent to smartphones or tablets, displaying the location and behavior of suspicious persons. The detection unit can also provide a feedback loop to continuously improve the accuracy of abnormal behavior detection. This allows the detection unit to retrain the AI model based on collected data and improve detection accuracy. In this way, the detection unit can quickly and accurately analyze collected video and identify suspicious persons at an early stage.

The cropping unit crops only the necessary portions based on the suspicious persons detected by the detection unit. The cropping unit can use AI to analyze video footage from security cameras and extract only portions that include moments of shoplifting or suspicious behavior. Specifically, the AI tracks the movements of persons in the video and identifies the time periods and locations where abnormal behavior occurred. This enables efficient cropping of only the necessary portions from long video footage. The cropping unit can efficiently store only the necessary portions as evidence and reduce data storage requirements. For example, it can crop and store several minutes of footage before and after the moment of shoplifting or suspicious behavior. In addition, the cropping unit can use video compression technology to optimize data storage while maintaining video quality. This allows the stored video to be played back in high quality when reviewed later. Furthermore, the cropping unit can share the cropped video with other systems or departments. For example, by providing it to the police or security companies, prompt response becomes possible. In this way, the cropping unit can efficiently extract and store only the necessary portions as evidence.

The report generation unit generates a report based on the video cropped by the cropping unit. The report generation unit can use AI to record the actions of detected suspicious persons in detail and compile them into a report.

Specifically, it can describe what actions were taken, at what time, and in which location. The AI analyzes the movements of persons in the video and creates a detailed timeline of actions. For example, it records the time a product was picked up, the route walked in the store, the moment of shoplifting, etc., in detail. In addition, the AI evaluates the abnormality and risk level of the actions and reflects them in the report. This allows the staff to grasp the actions of suspicious persons at a glance. The report generation unit saves the created report in digital format and can print it as needed. Furthermore, the report generation unit can cooperate with other systems or departments to share the report. For example, by providing it to the police or security companies, prompt response becomes possible. In this way, the report generation unit can record the actions of suspicious persons in detail and efficiently generate reports.

The detection unit can analyze video footage from security cameras and identify persons exhibiting abnormal behavior. For example, the detection unit can use AI to analyze video footage from security cameras and identify persons exhibiting abnormal behavior. The detection unit can detect behaviors such as picking up a product and immediately putting it back, or walking around the store unnaturally. The detection unit can use AI to quickly detect persons exhibiting abnormal behavior and notify the staff. By identifying persons exhibiting abnormal behavior, early detection of shoplifting becomes possible. Some or all of the above-described processing in the detection unit may be performed using AI or without using AI. For example, the detection unit can input video footage from security cameras to AI and have the AI identify persons exhibiting abnormal behavior.

The cropping unit can crop only necessary portions from the video detected by the detection unit. For example, the cropping unit can use AI to analyze video footage from security cameras and extract only portions that include moments of shoplifting or suspicious behavior. The cropping unit can efficiently store only the necessary portions as evidence and reduce data storage requirements. By efficiently cropping only the necessary portions, data storage requirements can be reduced. Some or all of the above-described processing in the cropping unit may be performed using AI or without using AI. For example, the cropping unit can input video footage from security cameras to AI and have the AI extract the necessary portions.

The report generation unit can generate a report based on the video cropped by the cropping unit. For example, the report generation unit can use AI to record the actions of detected suspicious persons in detail and compile them into a report. The report generation unit can describe what actions were taken, at what time, and in which location. This streamlines report generation and makes it easier to identify the perpetrator. Some or all of the above-described processing in the report generation unit may be performed using AI or without using AI. For example, the report generation unit can input the cropped video to AI and have the AI generate the report.

The collection unit can collect video footage from a plurality of security cameras. For example, the collection unit can use cameras that cover the entire area of the store or cameras that focus on specific areas. The collection unit can use AI to efficiently collect video footage from security cameras. By collecting video from multiple security cameras, wide-area monitoring becomes possible. Some or all of the above-described processing in the collection unit may be performed using AI or without using AI. For example, the collection unit can input video from multiple security cameras to AI and have the AI perform the video collection.

The detection unit can detect behaviors such as picking up a product and immediately putting it back, or walking around the store unnaturally. For example, the detection unit can use AI to analyze video footage from security cameras and detect behaviors such as picking up a product and immediately putting it back, or walking around the store unnaturally. The detection unit can use AI to quickly detect persons exhibiting abnormal behavior and notify the staff. By detecting specific behavior patterns, persons with a high possibility of shoplifting can be detected early. Some or all of the above-described processing in the detection unit may be performed using AI or without using AI. For example, the detection unit can input video footage from security cameras to AI and have the AI detect specific behavior patterns.

The collection unit can dynamically adjust the installation position of security cameras to perform optimal video collection. For example, the collection unit can use AI to dynamically adjust the installation position of security cameras and collect optimal video. The collection unit can automatically adjust the installation position of cameras according to the congestion status in the store and collect optimal video. For example, if abnormal behavior is detected in a specific area, the collection unit can concentrate cameras in that area. The collection unit can dynamically adjust the installation position of cameras according to changes in store layout. By dynamically adjusting the installation position of security cameras, optimal video collection becomes possible. Some or all of the above-described processing in the collection unit may be performed using AI or without using AI. For example, the collection unit can input the installation position of security cameras to AI and have the AI perform the adjustment of the installation position.

The collection unit can change the collection method during video collection based on specific time periods or days of the week. For example, the collection unit can use AI to change the collection method during video collection based on specific time periods or days of the week. The collection unit can use the normal collection method during daytime on weekdays and increase the collection frequency at night or on weekends. The collection unit can strengthen the collection method and collect detailed video on days when specific events are held. The collection unit can change the collection method during time periods when shoplifting frequently occurs based on past data. By changing the collection method based on specific time periods or days of the week, efficient video collection becomes possible. Some or all of the above-described processing in the collection unit may be performed using AI or without using AI. For example, the collection unit can input data on specific time periods or days of the week to AI and have the AI perform the change of collection method.

The collection unit can adjust the collection method during video collection based on weather or lighting conditions. For example, the collection unit can use AI to adjust the collection method during video collection based on weather or lighting conditions. The collection unit can prioritize indoor video collection during rainy weather. The collection unit can use infrared cameras to collect video when lighting is poor. The collection unit can strengthen outdoor video collection during clear weather. By adjusting the collection method according to weather or lighting conditions, optimal video collection becomes possible. Some or all of the above-described processing in the collection unit may be performed using AI or without using AI. For example, the collection unit can input data on weather or lighting conditions to AI and have the AI perform the adjustment of the collection method.

The collection unit can analyze the congestion status in the store during video collection and select the optimal collection method. For example, the collection unit can use AI to analyze the congestion status in the store during video collection and select the optimal collection method. The collection unit can collect wide-area video when the store is crowded. The collection unit can focus on specific areas and collect video when the store is empty. The collection unit can adjust the camera collection angle according to the congestion status. By selecting the collection method according to the congestion status in the store, efficient video collection becomes possible. Some or all of the above-described processing in the collection unit may be performed using AI or without using AI. For example, the collection unit can input data on the congestion status in the store to AI and have the AI perform the selection of the collection method.

The detection unit can optimize the detection algorithm during detection based on past shoplifting data. For example, the detection unit can use AI to optimize the detection algorithm during detection based on past shoplifting data. The detection unit can optimize the algorithm for detecting specific behavior patterns based on past shoplifting data. The detection unit can adjust the detection algorithm to predict shoplifting that occurs at specific time periods or days of the week based on past data. The detection unit can analyze past data and develop algorithms to respond to new shoplifting methods. By optimizing the detection algorithm based on past shoplifting data, detection accuracy is improved. Some or all of the above-described processing in the detection unit may be performed using AI or without using AI. For example, the detection unit can input past shoplifting data to AI and have the AI perform the optimization of the detection algorithm.

The detection unit can identify abnormal behavior during detection based on attribute information of a person. For example, the detection unit can use AI to identify abnormal behavior during detection based on attribute information of a person. The detection unit can detect specific behavior patterns based on age or gender. The detection unit can adjust the criteria for detecting abnormal behavior based on attribute information. The detection unit can consider attribute information and quickly detect abnormal behavior for specific persons. By identifying abnormal behavior based on attribute information of a person, detection accuracy is improved. Some or all of the above-described processing in the detection unit may be performed using AI or without using AI. For example, the detection unit can input attribute information of a person to AI and have the AI perform the identification of abnormal behavior.

The detection unit can identify abnormal behavior during detection based on store layout information. For example, the detection unit can use AI to identify abnormal behavior during detection based on store layout information. The detection unit can detect abnormal behavior in specific areas based on store layout information. The detection unit can adjust the criteria for detecting abnormal behavior according to layout changes. The detection unit can consider layout information and detect abnormal behavior focused on specific areas. By identifying abnormal behavior based on store layout information, detection accuracy is improved. Some or all of the above-described processing in the detection unit may be performed using AI or without using AI. For example, the detection unit can input store layout information to AI and have the AI perform the identification of abnormal behavior.

The detection unit can identify abnormal behavior during detection in cooperation with other security systems. For example, the detection unit can use AI to identify abnormal behavior during detection in cooperation with other security systems. The detection unit can cooperate with alarm systems and trigger an alarm when abnormal behavior is detected. The detection unit can improve the accuracy of abnormal behavior detection based on data from other security systems. The detection unit can cooperate with other security systems to respond quickly when abnormal behavior is detected. By cooperating with other security systems, the accuracy of abnormal behavior detection is improved. Some or all of the above-described processing in the detection unit may be performed using AI or without using AI. For example, the detection unit can input data from other security systems to AI and have the AI perform the identification of abnormal behavior.

The cropping unit can optimize video quality during cropping and extract necessary portions. For example, the cropping unit can use AI to optimize video quality during cropping and extract necessary portions. The cropping unit can adjust the resolution of the video and crop necessary portions in high quality. The cropping unit can remove noise from the video and crop clear footage. The cropping unit can adjust the brightness and contrast of the video and perform cropping at optimal quality. By optimizing video quality, necessary portions can be extracted in high quality. Some or all of the above-described processing in the cropping unit may be performed using AI or without using AI. For example, the cropping unit can input video quality data to AI and have the AI perform the optimization of video quality.

The cropping unit can integrate multiple camera videos during cropping to perform optimal cropping. For example, the cropping unit can use AI to integrate multiple camera videos during cropping and perform optimal cropping. The cropping unit can integrate multiple camera videos and crop footage from different angles. The cropping unit can analyze multiple camera videos and crop the most important portions. The cropping unit can combine multiple camera videos to perform cropping that provides an overall view. By integrating multiple camera videos, footage from different angles can be efficiently cropped. Some or all of the above-described processing in the cropping unit may be performed using AI or without using AI. For example, the cropping unit can input multiple camera videos to AI and have the AI perform video integration and cropping.

The cropping unit can adjust the video timeline during cropping and extract optimal portions. For example, the cropping unit can use AI to adjust the video timeline during cropping and extract optimal portions. The cropping unit can adjust the video timeline and extract important portions. The cropping unit can compress the video timeline and display important portions in a short time. The cropping unit can expand the video timeline and extract detailed portions. By adjusting the video timeline, important portions can be efficiently extracted. Some or all of the above-described processing in the cropping unit may be performed using AI or without using AI. For example, the cropping unit can input video timeline data to AI and have the AI perform the adjustment of the timeline.

The cropping unit can analyze audio data of the video during cropping and extract necessary portions. For example, the cropping unit can use AI to analyze audio data of the video during cropping and extract necessary portions. The cropping unit can analyze audio data of the video and extract portions containing important conversations or sounds. The cropping unit can detect abnormal sounds based on audio data and crop those portions. The cropping unit can analyze audio data and extract portions containing specific keywords. By analyzing audio data, portions containing important conversations or sounds can be efficiently extracted. Some or all of the above-described processing in the cropping unit may be performed using AI or without using AI. For example, the cropping unit can input audio data to AI and have the AI perform the extraction of necessary portions.

The report generation unit can select the optimal report format during report generation based on past report data. For example, the report generation unit can use AI to select the optimal report format during report generation based on past report data. The report generation unit can select the most effective report format based on past report data. The report generation unit can propose a report format suitable for specific situations based on past report data. The report generation unit can analyze past report data and develop new report formats. By selecting the optimal report format based on past report data, effective reports can be created. Some or all of the above-described processing in the report generation unit may be performed using AI or without using AI. For example, the report generation unit can input past report data to AI and have the AI perform the selection of the report format.

The report generation unit can automatically add video metadata during report generation. For example, the report generation unit can use AI to automatically add video metadata during report generation. The report generation unit can automatically add the shooting date and time of the video to the report. The report generation unit can automatically add the shooting location of the video to the report. The report generation unit can create a detailed report based on video metadata. By automatically adding video metadata, detailed reports can be efficiently created. Some or all of the above-described processing in the report generation unit may be performed using AI or without using AI. For example, the report generation unit can input video metadata to AI and have the AI perform the addition of metadata.

The report generation unit can integrate data from other security systems during report generation and generate a report. For example, the report generation unit can use AI to integrate data from other security systems during report generation and generate a report. The report generation unit can create a detailed report based on data from other security systems. The report generation unit can cooperate with other security systems and generate a report based on integrated data. The report generation unit can analyze data from other security systems and create the optimal report. By integrating data from other security systems, detailed reports can be efficiently created. Some or all of the above-described processing in the report generation unit may be performed using AI or without using AI. For example, the report generation unit can input data from other security systems to AI and have the AI perform report generation.

The report generation unit can select a report transmission method during report generation. For example, the report generation unit can use AI to select a report transmission method during report generation. The report generation unit can select a method for sending the report by email. The report generation unit can select a method for sharing the report via the cloud. The report generation unit can select a report transmission method according to user needs. By selecting the report transmission method, reports can be sent according to user needs. Some or all of the above-described processing in the report generation unit may be performed using AI or without using AI. For example, the report generation unit can input data on transmission methods to AI and have the AI perform the selection of the transmission method.

The system according to the embodiment is not limited to the above-described examples and can be variously modified, for example, as follows.

The shoplifting G-Men AI may further include an audio analysis unit. The audio analysis unit can analyze audio data included in video footage from security cameras and detect abnormal sounds or conversations. For example, the audio analysis unit can detect sounds of products being put into bags or unnatural conversations with store staff. By utilizing not only video but also audio data, the accuracy of shoplifting detection is improved. The audio analysis unit can use AI to analyze audio data and detect abnormal sounds or conversations. The audio analysis unit can detect conversations containing specific keywords and notify the staff. The audio analysis unit can identify persons exhibiting abnormal behavior based on audio data.

The shoplifting G-Men AI may further include a face recognition unit. The face recognition unit can recognize the faces of persons appearing in video footage from security cameras and identify persons suspected of shoplifting in the past. For example, the face recognition unit can match with a past shoplifting database and identify the same person. This enables early detection of persons with a high possibility of repeat offenses and notifies the staff. The face recognition unit can use AI to perform face recognition and match with past databases. The face recognition unit can detect persons with specific features and issue warnings. The face recognition unit can integrate multiple camera videos to improve the accuracy of face recognition.

The shoplifting G-Men AI may further include a behavior prediction unit. The behavior prediction unit can analyze video footage from security cameras and predict the behavior of persons. For example, the behavior prediction unit can predict what action will be taken next based on past behavior patterns. This enables early detection of actions with a high possibility of shoplifting and notifies the staff. The behavior prediction unit can use AI to analyze behavior patterns and make predictions. The behavior prediction unit can predict behavior in specific areas and adjust the camera focus. The behavior prediction unit can issue warnings when abnormal behavior is predicted.

The shoplifting G-Men AI may further include a temperature sensor unit. The temperature sensor unit can monitor the temperature inside the store and detect abnormal temperature changes. For example, if there is a sudden temperature change in a specific area, the temperature sensor unit can concentrate cameras in that area. This enables early detection of abnormal behavior based on temperature changes and notifies the staff. The temperature sensor unit can use AI to analyze temperature data and detect abnormal temperature changes. The temperature sensor unit can issue warnings when a specific temperature range is exceeded. The temperature sensor unit can predict the possibility of abnormal behavior based on temperature data.

The shoplifting G-Men AI may further include a vibration sensor unit. The vibration sensor unit can monitor vibrations in the store and detect abnormal vibrations. For example, the vibration sensor unit can monitor vibrations of product shelves and, if abnormal vibrations are detected, concentrate cameras in that area. This enables early detection of abnormal behavior based on vibrations and notifies the staff. The vibration sensor unit can use AI to analyze vibration data and detect abnormal vibrations. The vibration sensor unit can detect specific vibration patterns and issue warnings. The vibration sensor unit can predict the possibility of abnormal behavior based on vibration data.

The following is a brief description of the processing flow of Example 1 of the Embodiment.
Step 1: The collection unit collects video footage from security cameras. For example, the collection unit can collect video from multiple security cameras. The collection unit can use cameras that cover the entire area of the store or cameras that focus on specific areas. The collection unit can use AI to efficiently collect video footage from security cameras.
Step 2: The detection unit analyzes the video footage collected by the collection unit and detects suspicious persons. For example, the detection unit can use AI to analyze video footage from security cameras and identify persons exhibiting abnormal behavior. The detection unit can detect behaviors such as picking up a product and immediately putting it back, or walking around the store unnaturally. The detection unit can use AI to quickly detect persons exhibiting abnormal behavior and notify the staff.
Step 3: The cropping unit crops only the necessary portions based on the suspicious persons detected by the detection unit. For example, the cropping unit can use AI to analyze video footage from security cameras and extract only portions that include moments of shoplifting or suspicious behavior. The cropping unit can efficiently store only the necessary portions as evidence and reduce data storage requirements.
Step 4: The report generation unit generates a report based on the video cropped by the cropping unit. For example, the report generation unit can use AI to record the actions of detected suspicious persons in detail and compile them into a report. The report generation unit can describe what actions were taken, at what time, and in which location.

### Example 2 of Embodiment

The shoplifting G-Men AI according to the embodiment of the present invention is a security system for supermarkets and convenience stores. This security system reads video from multiple security cameras and provides the following functions. First, it detects suspicious persons and notifies the staff. The AI analyzes video footage from security cameras and identifies persons exhibiting abnormal behavior. For example, it detects behaviors such as picking up a product and immediately putting it back, or walking around the store unnaturally. This enables early detection of persons who may be shoplifting and notifies the staff. Next, it crops only the necessary portions from the vast amount of video and generates small-sized video files. The AI analyzes video footage from security cameras and extracts only portions that include moments of shoplifting or suspicious behavior. This allows only the necessary portions to be efficiently stored as evidence and reduces data storage requirements. Furthermore, it generates a report for suspect identification. The AI records the actions of detected suspicious persons in detail and compiles them into a report. For example, it describes what actions were taken, at what time, and in which location. This makes it easier to identify the perpetrator and enables smooth reporting to the police and submission of evidence. In this way, the shoplifting G-Men AI aims to eliminate shoplifting damage through detection of suspicious persons, cropping of necessary video, and report generation for suspect identification. As a result, the shoplifting G-Men AI enables efficient collection, analysis, cropping, and report generation of security camera footage.

The shoplifting G-Men AI according to the embodiment includes a collection unit, a detection unit, a cropping unit, and a report generation unit. The collection unit collects video footage from security cameras. For example, the collection unit can collect video from multiple security cameras. The collection unit can use cameras that cover the entire area of the store or cameras that focus on specific areas. The collection unit can also use AI to efficiently collect video footage from security cameras. The detection unit analyzes the video footage collected by the collection unit and detects suspicious persons. For example, the detection unit can use AI to analyze video footage from security cameras and identify persons exhibiting abnormal behavior. The detection unit can detect behaviors such as picking up a product and immediately putting it back, or walking around the store unnaturally. The detection unit can use AI to quickly detect persons exhibiting abnormal behavior and notify the staff. The cropping unit crops only the necessary portions based on the suspicious persons detected by the detection unit. For example, the cropping unit can use AI to analyze video footage from security cameras and extract only portions that include moments of shoplifting or suspicious behavior. The cropping unit can efficiently store only the necessary portions as evidence and reduce data storage requirements. The report generation unit generates a report based on the video cropped by the cropping unit. For example, the report generation unit can use AI to record the actions of detected suspicious persons in detail and compile them into a report. The report generation unit can describe what actions were taken, at what time, and in which location. As a result, the shoplifting G-Men AI according to the embodiment enables efficient collection, analysis, cropping, and report generation of security camera footage.

The collection unit collects video footage from security cameras. For example, the collection unit can collect video from multiple security cameras. Specifically, cameras that cover the entire area of the store or cameras that focus on specific areas can be used. This enables thorough monitoring of every corner of the store and reduces the risk of shoplifting. The collection unit can use AI to efficiently collect video footage from security cameras. The AI automatically adjusts the quality and resolution of the video and collects data in an optimal state. For example, it can correct distortions in the video caused by changes in lighting or camera position and obtain clear footage. In addition, the collection unit collects video in real time and transmits it to a central database. This ensures that the latest footage is always stored and can be used for subsequent analysis and detection. Furthermore, the collection unit can use video data compression technology to efficiently manage data storage. This enables long-term storage of large amounts of video data and allows for retrospective review of past footage. The collection unit can also cooperate with other systems or departments to share data as needed. For example, by cooperating with the police or security companies and providing the collected video data, prompt response becomes possible. In this way, the collection unit can efficiently and effectively collect video footage from security cameras and improve the overall performance of the system.

The detection unit analyzes the video footage collected by the collection unit and detects suspicious persons. The detection unit uses AI to analyze video footage from security cameras and identify persons exhibiting abnormal behavior. Specifically, it can detect behaviors such as picking up a product and immediately putting it back, or walking around the store unnaturally. The AI tracks the movements of persons in the video and detects abnormalities by comparing them with normal behavior patterns. For example, the AI analyzes the speed and direction of movement, length of stay, etc., and identifies behavior that differs from the norm. In addition, the AI learns from past data and models typical shoplifting behavior patterns, enabling more accurate detection. The detection unit can quickly detect persons exhibiting abnormal behavior and notify the staff. Notifications are made in real time, allowing staff to respond immediately. For example, alerts can be sent to smartphones or tablets, displaying the location and behavior of suspicious persons. The detection unit can also provide a feedback loop to continuously improve the accuracy of abnormal behavior detection. This allows the detection unit to retrain the AI model based on collected data and improve detection accuracy. In this way, the detection unit can quickly and accurately analyze collected video and identify suspicious persons at an early stage.

The cropping unit crops only the necessary portions based on the suspicious persons detected by the detection unit. The cropping unit can use AI to analyze video footage from security cameras and extract only portions that include moments of shoplifting or suspicious behavior. Specifically, the AI tracks the movements of persons in the video and identifies the time periods and locations where abnormal behavior occurred. This enables efficient cropping of only the necessary portions from long video footage. The cropping unit can efficiently store only the necessary portions as evidence and reduce data storage requirements. For example, it can crop and store several minutes of footage before and after the moment of shoplifting or suspicious behavior. In addition, the cropping unit can use video compression technology to optimize data storage while maintaining video quality. This allows the stored video to be played back in high quality when reviewed later. Furthermore, the cropping unit can share the cropped video with other systems or departments. For example, by providing it to the police or security companies, prompt response becomes possible. In this way, the cropping unit can efficiently extract and store only the necessary portions as evidence.

The report generation unit generates a report based on the video cropped by the cropping unit. The report generation unit can use AI to record the actions of detected suspicious persons in detail and compile them into a report. Specifically, it can describe what actions were taken, at what time, and in which location. The AI analyzes the movements of persons in the video and creates a detailed timeline of actions. For example, it records the time a product was picked up, the route walked in the store, the moment of shoplifting, etc., in detail. In addition, the AI evaluates the abnormality and risk level of the actions and reflects them in the report. This allows the staff to grasp the actions of suspicious persons at a glance. The report generation unit saves the created report in digital format and can print it as needed. Furthermore, the report generation unit can cooperate with other systems or departments to share the report. For example, by providing it to the police or security companies, prompt response becomes possible. In this way, the report generation unit can record the actions of suspicious persons in detail and efficiently generate reports.

The detection unit can analyze video footage from security cameras and identify persons exhibiting abnormal behavior. For example, the detection unit can use AI to analyze video footage from security cameras and identify persons exhibiting abnormal behavior. The detection unit can detect behaviors such as picking up a product and immediately putting it back, or walking around the store unnaturally. The detection unit can use AI to quickly detect persons exhibiting abnormal behavior and notify the staff. By identifying persons exhibiting abnormal behavior, early detection of shoplifting becomes possible. Some or all of the above-described processing in the detection unit may be performed using AI or without using AI. For example, the detection unit can input video footage from security cameras to AI and have the AI identify persons exhibiting abnormal behavior.

The cropping unit can crop only necessary portions from the video detected by the detection unit. For example, the cropping unit can use AI to analyze video footage from security cameras and extract only portions that include moments of shoplifting or suspicious behavior. The cropping unit can efficiently store only the necessary portions as evidence and reduce data storage requirements. By efficiently cropping only the necessary portions, data storage requirements can be reduced. Some or all of the above-described processing in the cropping unit may be performed using AI or without using AI. For example, the cropping unit can input video footage from security cameras to AI and have the AI extract the necessary portions.

The report generation unit can generate a report based on the video cropped by the cropping unit. For example, the report generation unit can use AI to record the actions of detected suspicious persons in detail and compile them into a report. The report generation unit can describe what actions were taken, at what time, and in which location. This streamlines report generation and makes it easier to identify the perpetrator. Some or all of the above-described processing in the report generation unit may be performed using AI or without using AI. For example, the report generation unit can input the cropped video to AI and have the AI generate the report.

The collection unit can collect video footage from a plurality of security cameras. For example, the collection unit can use cameras that cover the entire area of the store or cameras that focus on specific areas. The collection unit can use AI to efficiently collect video footage from security cameras. By collecting video from multiple security cameras, wide-area monitoring becomes possible. Some or all of the above-described processing in the collection unit may be performed using AI or without using AI. For example, the collection unit can input video from multiple security cameras to AI and have the AI perform the video collection.

The detection unit can detect behaviors such as picking up a product and immediately putting it back, or walking around the store unnaturally. For example, the detection unit can use AI to analyze video footage from security cameras and detect behaviors such as picking up a product and immediately putting it back, or walking around the store unnaturally. The detection unit can use AI to quickly detect persons exhibiting abnormal behavior and notify the staff. By detecting specific behavior patterns, persons with a high possibility of shoplifting can be detected early. Some or all of the above-described processing in the detection unit may be performed using AI or without using AI. For example, the detection unit can input video footage from security cameras to AI and have the AI detect specific behavior patterns.

The collection unit can estimate a user's emotion and adjust the timing of collecting video footage from security cameras based on the estimated emotion of the user. For example, the collection unit can use AI to estimate a user's emotion and adjust the timing of collecting video footage from security cameras based on the estimated emotion. If the user is nervous, the collection timing can be made more frequent to collect detailed video. If the user is relaxed, the collection timing can be spaced out to collect only the necessary video. If the user is in a hurry, the collection timing can be shortened to quickly collect video. By adjusting the video collection timing according to the user's emotion, more effective monitoring becomes possible. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the collection unit may be performed using AI or without using AI. For example, the collection unit can input the user's emotion data to AI and have the AI perform the adjustment of video collection timing.

The collection unit can dynamically adjust the installation position of security cameras to perform optimal video collection. For example, the collection unit can use AI to dynamically adjust the installation position of security cameras and collect optimal video. The collection unit can automatically adjust the installation position of cameras according to the congestion status in the store and collect optimal video. For example, if abnormal behavior is detected in a specific area, the collection unit can concentrate cameras in that area. The collection unit can dynamically adjust the installation position of cameras according to changes in store layout. By dynamically adjusting the installation position of security cameras, optimal video collection becomes possible. Some or all of the above-described processing in the collection unit may be performed using AI or without using AI. For example, the collection unit can input the installation position of security cameras to AI and have the AI perform the adjustment of the installation position.

The collection unit can change the collection method during video collection based on specific time periods or days of the week. For example, the collection unit can use AI to change the collection method during video collection based on specific time periods or days of the week. The collection unit can use the normal collection method during daytime on weekdays and increase the collection frequency at night or on weekends. The collection unit can strengthen the collection method and collect detailed video on days when specific events are held. The collection unit can change the collection method during time periods when shoplifting frequently occurs based on past data. By changing the collection method based on specific time periods or days of the week, efficient video collection becomes possible. Some or all of the above-described processing in the collection unit may be performed using AI or without using AI. For example, the collection unit can input data on specific time periods or days of the week to AI and have the AI perform the change of collection method.

The collection unit can estimate a user's emotion and determine the priority of video to be collected based on the estimated emotion of the user. For example, the collection unit can use AI to estimate a user's emotion and determine the priority of video to be collected based on the estimated emotion. If the user is nervous, video from important areas can be collected with higher priority. If the user is relaxed, video can be collected with normal priority. If the user is in a hurry, important video can be collected quickly. By determining the priority of video according to the user's emotion, important video can be collected with higher priority. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the collection unit may be performed using AI or without using AI. For example, the collection unit can input the user's emotion data to AI and have the AI perform the determination of video priority.

The collection unit can adjust the collection method during video collection based on weather or lighting conditions. For example, the collection unit can use AI to adjust the collection method during video collection based on weather or lighting conditions. The collection unit can prioritize indoor video collection during rainy weather. The collection unit can use infrared cameras to collect video when lighting is poor. The collection unit can strengthen outdoor video collection during clear weather. By adjusting the collection method according to weather or lighting conditions, optimal video collection becomes possible. Some or all of the above-described processing in the collection unit may be performed using AI or without using AI. For example, the collection unit can input data on weather or lighting conditions to AI and have the AI perform the adjustment of the collection method.

The collection unit can analyze the congestion status in the store during video collection and select the optimal collection method. For example, the collection unit can use AI to analyze the congestion status in the store during video collection and select the optimal collection method. The collection unit can collect wide-area video when the store is crowded. The collection unit can focus on specific areas and collect video when the store is empty. The collection unit can adjust the camera collection angle according to the congestion status. By selecting the collection method according to the congestion status in the store, efficient video collection becomes possible. Some or all of the above-described processing in the collection unit may be performed using AI or without using AI. For example, the collection unit can input data on the congestion status in the store to AI and have the AI perform the selection of the collection method.

The detection unit can estimate a user's emotion and adjust the criteria for detecting abnormal behavior based on the estimated emotion of the user. For example, the detection unit can use AI to estimate a user's emotion and adjust the criteria for detecting abnormal behavior based on the estimated emotion. If the user is nervous, the detection criteria can be made stricter to detect abnormal behavior at an early stage. If the user is relaxed, normal detection criteria can be used. If the user is in a hurry, the criteria can be adjusted to quickly detect abnormal behavior. By adjusting the detection criteria according to the user's emotion, the accuracy of abnormal behavior detection is improved. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the detection unit may be performed using AI or without using AI. For example, the detection unit can input the user's emotion data to AI and have the AI perform the adjustment of detection criteria.

The detection unit can optimize the detection algorithm during detection based on past shoplifting data. For example, the detection unit can use AI to optimize the detection algorithm during detection based on past shoplifting data. The detection unit can optimize the algorithm for detecting specific behavior patterns based on past shoplifting data. The detection unit can adjust the detection algorithm to predict shoplifting that occurs at specific time periods or days of the week based on past data. The detection unit can analyze past data and develop algorithms to respond to new shoplifting methods. By optimizing the detection algorithm based on past shoplifting data, detection accuracy is improved. Some or all of the above-described processing in the detection unit may be performed using AI or without using AI. For example, the detection unit can input past shoplifting data to AI and have the AI perform the optimization of the detection algorithm.

The detection unit can identify abnormal behavior during detection based on attribute information of a person. For example, the detection unit can use AI to identify abnormal behavior during detection based on attribute information of a person. The detection unit can detect specific behavior patterns based on age or gender. The detection unit can adjust the criteria for detecting abnormal behavior based on attribute information. The detection unit can consider attribute information and quickly detect abnormal behavior for specific persons. By identifying abnormal behavior based on attribute information of a person, detection accuracy is improved. Some or all of the above-described processing in the detection unit may be performed using AI or without using AI. For example, the detection unit can input attribute information of a person to AI and have the AI perform the identification of abnormal behavior.

The detection unit can estimate a user's emotion and adjust the display method of detection results based on the estimated emotion of the user. For example, the detection unit can use AI to estimate a user's emotion and adjust the display method of detection results based on the estimated emotion. If the user is nervous, a simple and highly visible display method can be provided. If the user is relaxed, a display method including detailed information can be provided. If the user is in a hurry, a display method focusing on key points can be provided. By adjusting the display method according to the user's emotion, visibility is improved. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the detection unit may be performed using AI or without using AI. For example, the detection unit can input the user's emotion data to AI and have the AI perform the adjustment of the display method.

The detection unit can identify abnormal behavior during detection based on store layout information. For example, the detection unit can use AI to identify abnormal behavior during detection based on store layout information. The detection unit can detect abnormal behavior in specific areas based on store layout information. The detection unit can adjust the criteria for detecting abnormal behavior according to layout changes. The detection unit can consider layout information and detect abnormal behavior focused on specific areas. By identifying abnormal behavior based on store layout information, detection accuracy is improved. Some or all of the above-described processing in the detection unit may be performed using AI or without using AI. For example, the detection unit can input store layout information to AI and have the AI perform the identification of abnormal behavior.

The detection unit can identify abnormal behavior during detection in cooperation with other security systems. For example, the detection unit can use AI to identify abnormal behavior during detection in cooperation with other security systems. The detection unit can cooperate with alarm systems and trigger an alarm when abnormal behavior is detected. The detection unit can improve the accuracy of abnormal behavior detection based on data from other security systems. The detection unit can cooperate with other security systems to respond quickly when abnormal behavior is detected. By cooperating with other security systems, the accuracy of abnormal behavior detection is improved. Some or all of the above-described processing in the detection unit may be performed using AI or without using AI. For example, the detection unit can input data from other security systems to AI and have the AI perform the identification of abnormal behavior.

The cropping unit can estimate a user's emotion and adjust the cropping range based on the estimated emotion of the user. For example, the cropping unit can use AI to estimate a user's emotion and adjust the cropping range based on the estimated emotion. If the user is nervous, more detailed portions can be cropped. If the user is relaxed, cropping can be performed within the normal range. If the user is in a hurry, necessary portions can be quickly cropped. By adjusting the cropping range according to the user's emotion, necessary portions can be efficiently extracted. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the cropping unit may be performed using AI or without using AI. For example, the cropping unit can input the user's emotion data to AI and have the AI perform the adjustment of the cropping range.

The cropping unit can optimize video quality during cropping and extract necessary portions. For example, the cropping unit can use AI to optimize video quality during cropping and extract necessary portions. The cropping unit can adjust the resolution of the video and crop necessary portions in high quality. The cropping unit can remove noise from the video and crop clear footage. The cropping unit can adjust the brightness and contrast of the video and perform cropping at optimal quality. By optimizing video quality, necessary portions can be extracted in high quality. Some or all of the above-described processing in the cropping unit may be performed using AI or without using AI. For example, the cropping unit can input video quality data to AI and have the AI perform the optimization of video quality.

The cropping unit can integrate multiple camera videos during cropping to perform optimal cropping. For example, the cropping unit can use AI to integrate multiple camera videos during cropping and perform optimal cropping. The cropping unit can integrate multiple camera videos and crop footage from different angles. The cropping unit can analyze multiple camera videos and crop the most important portions. The cropping unit can combine multiple camera videos to perform cropping that provides an overall view. By integrating multiple camera videos, footage from different angles can be efficiently cropped. Some or all of the above-described processing in the cropping unit may be performed using AI or without using AI. For example, the cropping unit can input multiple camera videos to AI and have the AI perform video integration and cropping.

The cropping unit can estimate a user's emotion and adjust the display method of cropped video based on the estimated emotion of the user. For example, the cropping unit can use AI to estimate a user's emotion and adjust the display method of cropped video based on the estimated emotion. If the user is nervous, a simple and highly visible display method can be provided. If the user is relaxed, a display method including detailed information can be provided. If the user is in a hurry, a display method focusing on key points can be provided. By adjusting the display method according to the user's emotion, visibility is improved. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the cropping unit may be performed using AI or without using AI. For example, the cropping unit can input the user's emotion data to AI and have the AI perform the adjustment of the display method.

The cropping unit can adjust the video timeline during cropping and extract optimal portions. For example, the cropping unit can use AI to adjust the video timeline during cropping and extract optimal portions. The cropping unit can adjust the video timeline and extract important portions. The cropping unit can compress the video timeline and display important portions in a short time. The cropping unit can expand the video timeline and extract detailed portions. By adjusting the video timeline, important portions can be efficiently extracted. Some or all of the above-described processing in the cropping unit may be performed using AI or without using AI. For example, the cropping unit can input video timeline data to AI and have the AI perform the adjustment of the timeline.

The cropping unit can analyze audio data of the video during cropping and extract necessary portions. For example, the cropping unit can use AI to analyze audio data of the video during cropping and extract necessary portions. The cropping unit can analyze audio data of the video and extract portions containing important conversations or sounds. The cropping unit can detect abnormal sounds based on audio data and crop those portions. The cropping unit can analyze audio data and extract portions containing specific keywords. By analyzing audio data, portions containing important conversations or sounds can be efficiently extracted. Some or all of the above-described processing in the cropping unit may be performed using AI or without using AI. For example, the cropping unit can input audio data to AI and have the AI perform the extraction of necessary portions.

The report generation unit can estimate a user's emotion and adjust the content of the report based on the estimated emotion of the user. For example, the report generation unit can use AI to estimate a user's emotion and adjust the content of the report based on the estimated emotion. If the user is nervous, a concise and to-the-point report can be created. If the user is relaxed, a report including detailed information can be created. If the user is in a hurry, a report that can be created quickly can be provided. By adjusting the content of the report according to the user's emotion, more appropriate reports can be created. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the report generation unit may be performed using AI or without using AI. For example, the report generation unit can input the user's emotion data to AI and have the AI perform the adjustment of the report content.

The report generation unit can select the optimal report format during report generation based on past report data. For example, the report generation unit can use AI to select the optimal report format during report generation based on past report data. The report generation unit can select the most effective report format based on past report data. The report generation unit can propose a report format suitable for specific situations based on past report data. The report generation unit can analyze past report data and develop new report formats. By selecting the optimal report format based on past report data, effective reports can be created. Some or all of the above-described processing in the report generation unit may be performed using AI or without using AI. For example, the report generation unit can input past report data to AI and have the AI perform the selection of the report format.

The report generation unit can automatically add video metadata during report generation. For example, the report generation unit can use AI to automatically add video metadata during report generation. The report generation unit can automatically add the shooting date and time of the video to the report. The report generation unit can automatically add the shooting location of the video to the report. The report generation unit can create a detailed report based on video metadata. By automatically adding video metadata, detailed reports can be efficiently created. Some or all of the above-described processing in the report generation unit may be performed using AI or without using AI. For example, the report generation unit can input video metadata to AI and have the AI perform the addition of metadata.

The report generation unit can estimate a user's emotion and determine the priority of the report based on the estimated emotion of the user. For example, the report generation unit can use AI to estimate a user's emotion and determine the priority of the report based on the estimated emotion. If the user is nervous, important reports can be created with higher priority. If the user is relaxed, reports can be created with normal priority. If the user is in a hurry, important reports can be created quickly. By determining the priority of reports according to the user's emotion, important reports can be created with higher priority. Emotion estimation is realized, for example, by using an emotion engine or a generative AI with emotion estimation functionality. The generative AI may be, for example, a text generation AI (such as an LLM) or a multimodal generative AI, but is not limited to such examples. Some or all of the above-described processing in the report generation unit may be performed using AI or without using AI. For example, the report generation unit can input the user's emotion data to AI and have the AI perform the determination of report priority.

The report generation unit can integrate data from other security systems during report generation and generate a report. For example, the report generation unit can use AI to integrate data from other security systems during report generation and generate a report. The report generation unit can create a detailed report based on data from other security systems. The report generation unit can cooperate with other security systems and generate a report based on integrated data. The report generation unit can analyze data from other security systems and create the optimal report. By integrating data from other security systems, detailed reports can be efficiently created. Some or all of the above-described processing in the report generation unit may be performed using AI or without using AI. For example, the report generation unit can input data from other security systems to AI and have the AI perform report generation.

The report generation unit can select a report transmission method during report generation. For example, the report generation unit can use AI to select a report transmission method during report generation. The report generation unit can select a method for sending the report by email. The report generation unit can select a method for sharing the report via the cloud. The report generation unit can select a report transmission method according to user needs. By selecting the report transmission method, reports can be sent according to user needs. Some or all of the above-described processing in the report generation unit may be performed using AI or without using AI. For example, the report generation unit can input data on transmission methods to AI and have the AI perform the selection of the transmission method.

The system according to the embodiment is not limited to the above-described examples and can be variously modified, for example, as follows.

The shoplifting G-Men AI may further include an audio analysis unit. The audio analysis unit can analyze audio data included in video footage from security cameras and detect abnormal sounds or conversations. For example, the audio analysis unit can detect sounds of products being put into bags or unnatural conversations with store staff. By utilizing not only video but also audio data, the accuracy of shoplifting detection is improved. The audio analysis unit can use AI to analyze audio data and detect abnormal sounds or conversations. The audio analysis unit can detect conversations containing specific keywords and notify the staff. The audio analysis unit can identify persons exhibiting abnormal behavior based on audio data.

The shoplifting G-Men AI may further include a face recognition unit. The face recognition unit can recognize the faces of persons appearing in video footage from security cameras and identify persons suspected of shoplifting in the past. For example, the face recognition unit can match with a past shoplifting database and identify the same person. This enables early detection of persons with a high possibility of repeat offenses and notifies the staff. The face recognition unit can use AI to perform face recognition and match with past databases. The face recognition unit can detect persons with specific features and issue warnings. The face recognition unit can integrate multiple camera videos to improve the accuracy of face recognition.

The shoplifting G-Men AI may further include a behavior prediction unit. The behavior prediction unit can analyze video footage from security cameras and predict the behavior of persons. For example, the behavior prediction unit can predict what action will be taken next based on past behavior patterns. This enables early detection of actions with a high possibility of shoplifting and notifies the staff. The behavior prediction unit can use AI to analyze behavior patterns and make predictions. The behavior prediction unit can predict behavior in specific areas and adjust the camera focus. The behavior prediction unit can issue warnings when abnormal behavior is predicted.

The shoplifting G-Men AI may further include a temperature sensor unit. The temperature sensor unit can monitor the temperature inside the store and detect abnormal temperature changes. For example, if there is a sudden temperature change in a specific area, the temperature sensor unit can concentrate cameras in that area. This enables early detection of abnormal behavior based on temperature changes and notifies the staff. The temperature sensor unit can use AI to analyze temperature data and detect abnormal temperature changes. The temperature sensor unit can issue warnings when a specific temperature range is exceeded. The temperature sensor unit can predict the possibility of abnormal behavior based on temperature data.

The shoplifting G-Men AI may further include a vibration sensor unit. The vibration sensor unit can monitor vibrations in the store and detect abnormal vibrations. For example, the vibration sensor unit can monitor vibrations of product shelves and, if abnormal vibrations are detected, concentrate cameras in that area. This enables early detection of abnormal behavior based on vibrations and notifies the staff. The vibration sensor unit can use AI to analyze vibration data and detect abnormal vibrations. The vibration sensor unit can detect specific vibration patterns and issue warnings. The vibration sensor unit can predict the possibility of abnormal behavior based on vibration data.

The shoplifting G-Men AI may further estimate a user's emotion and adjust the video analysis algorithm of security cameras based on the estimated emotion. For example, if the user is nervous, the analysis algorithm can be made stricter to detect abnormal behavior at an early stage. If the user is relaxed, the normal analysis algorithm can be used. By adjusting the analysis algorithm according to the user's emotion, the accuracy of abnormal behavior detection is improved. Emotion estimation is realized, for example, by using an emotion engine or a generative AI with emotion estimation functionality. The generative AI may be, for example, a text generation AI (such as an LLM) or a multimodal generative AI, but is not limited to such examples. The adjustment of the analysis algorithm may be performed using AI or without using AI. For example, the adjustment of the analysis algorithm can be performed by AI.

The shoplifting G-Men AI may further estimate a user's emotion and adjust the video storage method of security cameras based on the estimated emotion. For example, if the user is nervous, important video can be stored with higher priority. If the user is relaxed, the normal storage method can be used. By adjusting the video storage method according to the user's emotion, important video can be efficiently stored. Emotion estimation is realized, for example, by using an emotion engine or a generative AI with emotion estimation functionality. The generative AI may be, for example, a text generation AI (such as an LLM) or a multimodal generative AI, but is not limited to such examples. The adjustment of the storage method may be performed using AI or without using AI. For example, the adjustment of the storage method can be performed by AI.

The shoplifting G-Men AI may further estimate a user's emotion and adjust the video analysis speed of security cameras based on the estimated emotion. For example, if the user is nervous, the analysis speed can be increased to quickly detect abnormal behavior. If the user is relaxed, the normal analysis speed can be used. By adjusting the analysis speed according to the user's emotion, the accuracy of abnormal behavior detection is improved. Emotion estimation is realized, for example, by using an emotion engine or a generative AI with emotion estimation functionality. The generative AI may be, for example, a text generation AI (such as an LLM) or a multimodal generative AI, but is not limited to such examples. The adjustment of the analysis speed may be performed using AI or without using AI. For example, the adjustment of the analysis speed can be performed by AI.

The shoplifting G-Men AI may further estimate a user's emotion and adjust the display method of security camera video based on the estimated emotion. For example, if the user is nervous, a simple and highly visible display method can be provided. If the user is relaxed, a display method including detailed information can be provided. By adjusting the display method according to the user's emotion, visibility is improved. Emotion estimation is realized, for example, by using an emotion engine or a generative AI with emotion estimation functionality. The generative AI may be, for example, a text generation AI (such as an LLM) or a multimodal generative AI, but is not limited to such examples. The adjustment of the display method may be performed using AI or without using AI. For example, the adjustment of the display method can be performed by AI.

The shoplifting G-Men AI may further estimate a user's emotion and adjust the storage period of security camera video based on the estimated emotion. For example, if the user is nervous, the storage period for important video can be extended. If the user is relaxed, the normal storage period can be used. By adjusting the storage period according to the user's emotion, important video can be efficiently managed. Emotion estimation is realized, for example, by using an emotion engine or a generative AI with emotion estimation functionality. The generative AI may be, for example, a text generation AI (such as an LLM) or a multimodal generative AI, but is not limited to such examples. The adjustment of the storage period may be performed using AI or without using AI. For example, the adjustment of the storage period can be performed by AI.

The following is a brief description of the processing flow of Example 2 of the Embodiment.
Step 1: The collection unit collects video footage from security cameras. For example, the collection unit can collect video from multiple security cameras. The collection unit can use cameras that cover the entire area of the store or cameras that focus on specific areas. The collection unit can use AI to efficiently collect video footage from security cameras.
Step 2: The detection unit analyzes the video footage collected by the collection unit and detects suspicious persons. For example, the detection unit can use AI to analyze video footage from security cameras and identify persons exhibiting abnormal behavior. The detection unit can detect behaviors such as picking up a product and immediately putting it back, or walking around the store unnaturally. The detection unit can use AI to quickly detect persons exhibiting abnormal behavior and notify the staff.
Step 3: The cropping unit crops only the necessary portions based on the suspicious persons detected by the detection unit. For example, the cropping unit can use AI to analyze video footage from security cameras and extract only portions that include moments of shoplifting or suspicious behavior. The cropping unit can efficiently store only the necessary portions as evidence and reduce data storage requirements.
Step 4: The report generation unit generates a report based on the video cropped by the cropping unit. For example, the report generation unit can use AI to record the actions of detected suspicious persons in detail and compile them into a report. The report generation unit can describe what actions were taken, at what time, and in which location.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements, including the collection unit, detection unit, cropping unit, and report generation unit, is implemented by at least one of, for example, the smart device 14 and the data processing device 12. For example, the collection unit collects video footage from security cameras using the camera 42 of the smart device 14 or the communication I/F 26 of the data processing device 12. The detection unit is implemented, for example, by the specific processing unit 290 of the data processing device 12, analyzes video footage from security cameras, and identifies persons exhibiting abnormal behavior. The cropping unit is implemented, for example, by the specific processing unit 290 of the data processing device 12, and extracts only portions that include moments of shoplifting or suspicious behavior. The report generation unit is implemented, for example, by the specific processing unit 290 of the data processing device 12, records the actions of detected suspicious persons in detail, and compiles them into a report. The correspondence between each unit and the devices or control units is not limited to the above examples and can be variously modified.

### Second Embodiment

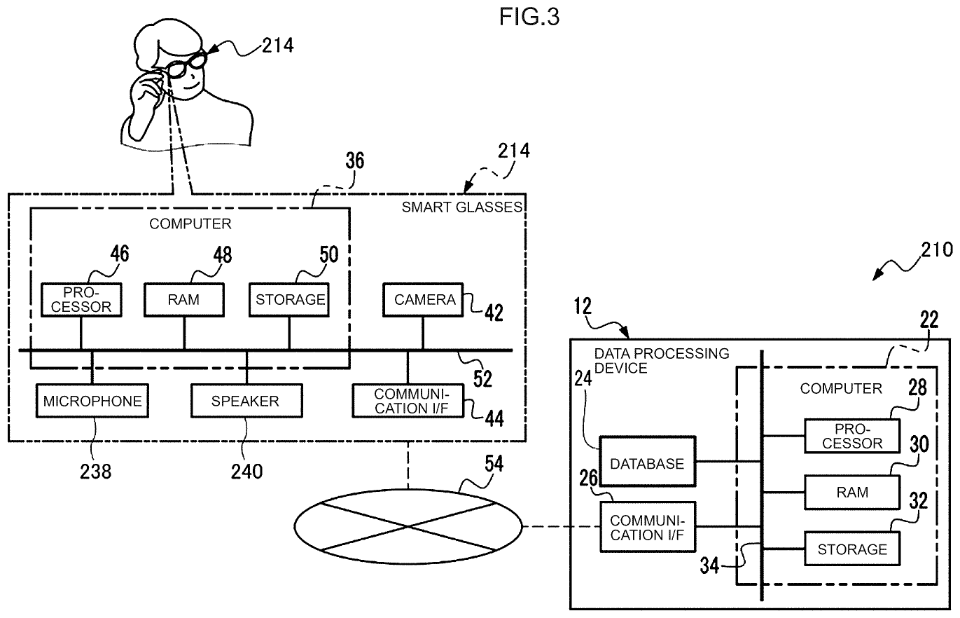

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

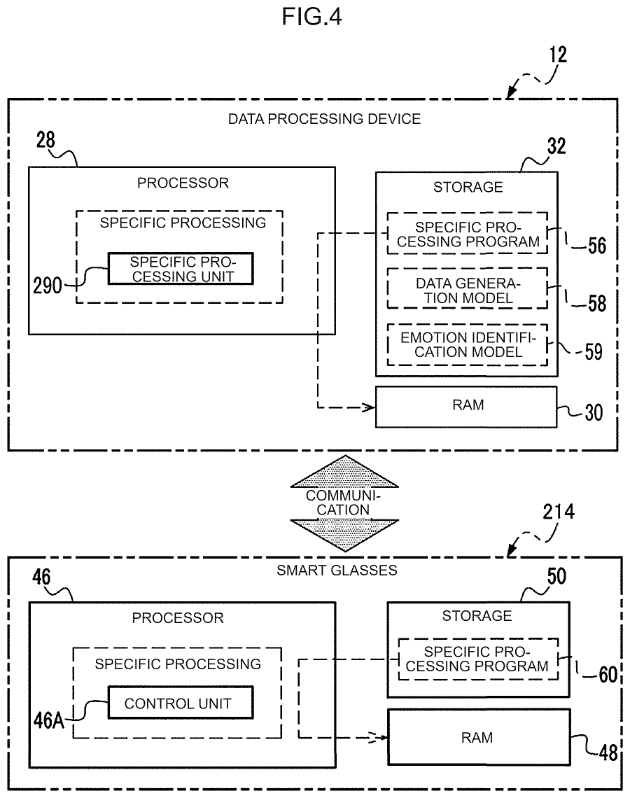

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements, including the collection unit, detection unit, cropping unit, and report generation unit, is implemented by at least one of, for example, the smart glasses 214 and the data processing device 12. For example, the collection unit collects video footage from security cameras using the camera 42 of the smart glasses 214 or the communication I/F 26 of the data processing device 12. The detection unit is implemented, for example, by the specific processing unit 290 of the data processing device 12, analyzes video footage from security cameras, and identifies persons exhibiting abnormal behavior. The cropping unit is implemented, for example, by the specific processing unit 290 of the data processing device 12, and extracts only portions that include moments of shoplifting or suspicious behavior. The report generation unit is implemented, for example, by the specific processing unit 290 of the data processing device 12, records the actions of detected suspicious persons in detail, and compiles them into a report. The correspondence between each unit and the devices or control units is not limited to the above examples and can be variously modified.

### Third Embodiment

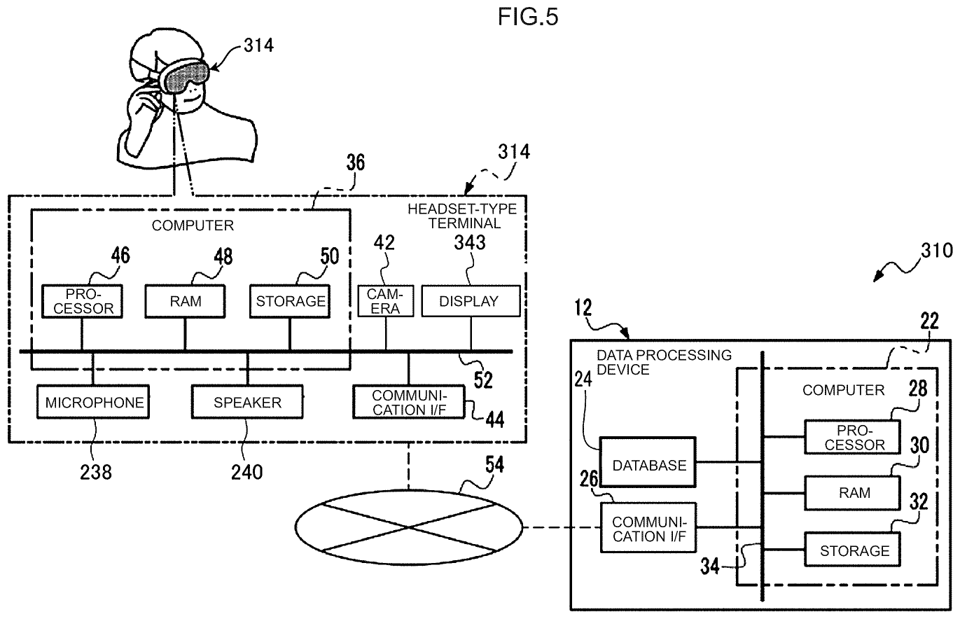

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

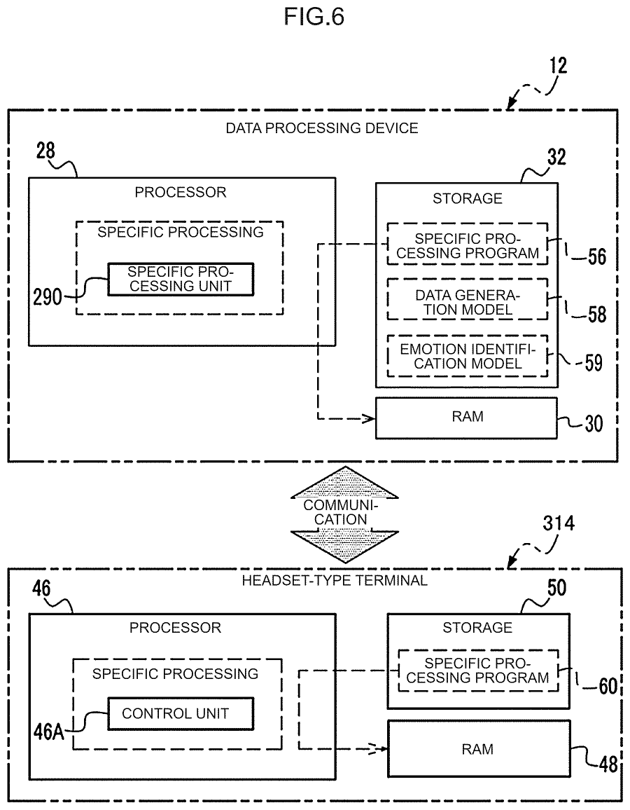

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements, including the collection unit, detection unit, cropping unit, and report generation unit, is implemented by at least one of, for example, the headset-type terminal 314 and the data processing device 12. For example, the collection unit collects video footage from security cameras using the camera 42 of the headset-type terminal 314 or the communication I/F 26 of the data processing device 12. The detection unit is implemented, for example, by the specific processing unit 290 of the data processing device 12, analyzes video footage from security cameras, and identifies persons exhibiting abnormal behavior. The cropping unit is implemented, for example, by the specific processing unit 290 of the data processing device 12, and extracts only portions that include moments of shoplifting or suspicious behavior. The report generation unit is implemented, for example, by the specific processing unit 290 of the data processing device 12, records the actions of detected suspicious persons in detail, and compiles them into a report. The correspondence between each unit and the devices or control units is not limited to the above examples and can be variously modified.

### Fourth Embodiment

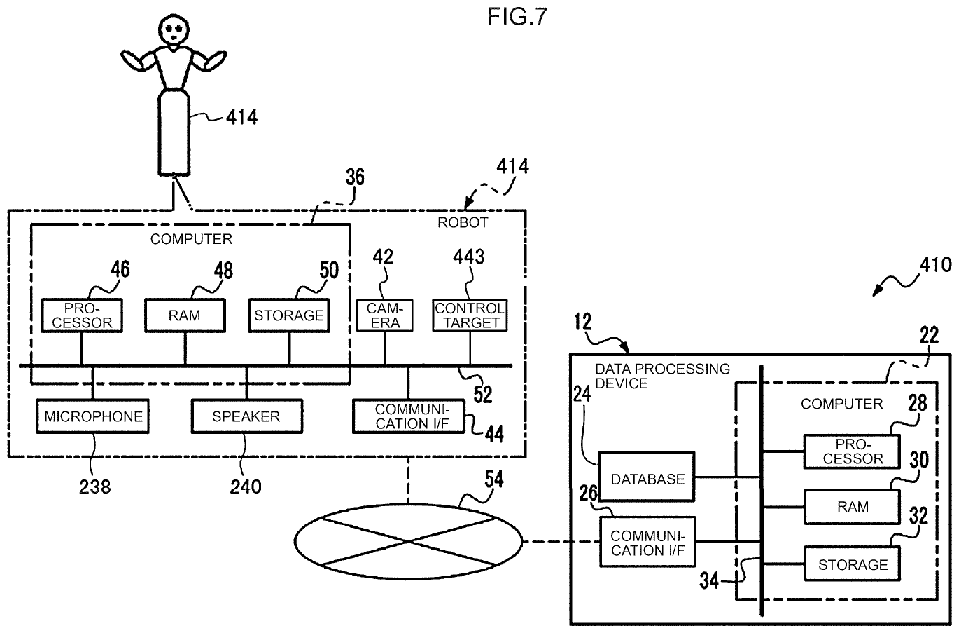

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

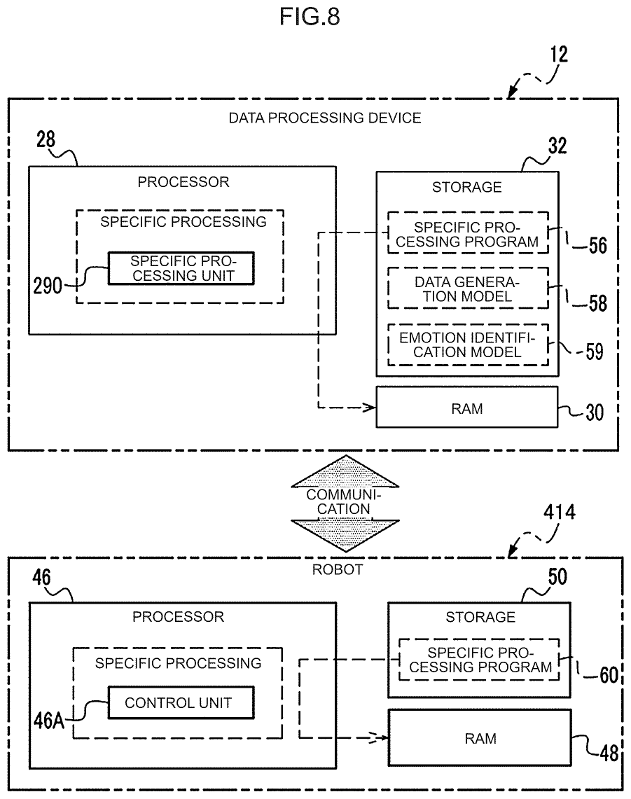

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements, including the collection unit, detection unit, cropping unit, and report generation unit, is implemented by at least one of, for example, the robot 414 and the data processing device 12. For example, the collection unit collects video footage from security cameras using the camera 42 of the robot 414 or the communication I/F 26 of the data processing device 12. The detection unit is implemented, for example, by the specific processing unit 290 of the data processing device 12, analyzes video footage from security cameras, and identifies persons exhibiting abnormal behavior. The cropping unit is implemented, for example, by the specific processing unit 290 of the data processing device 12, and extracts only portions that include moments of shoplifting or suspicious behavior.

The report generation unit is implemented, for example, by the specific processing unit 290 of the data processing device 12, records the actions of detected suspicious persons in detail, and compiles them into a report. The correspondence between each unit and the devices or control units is not limited to the above examples and can be variously modified.

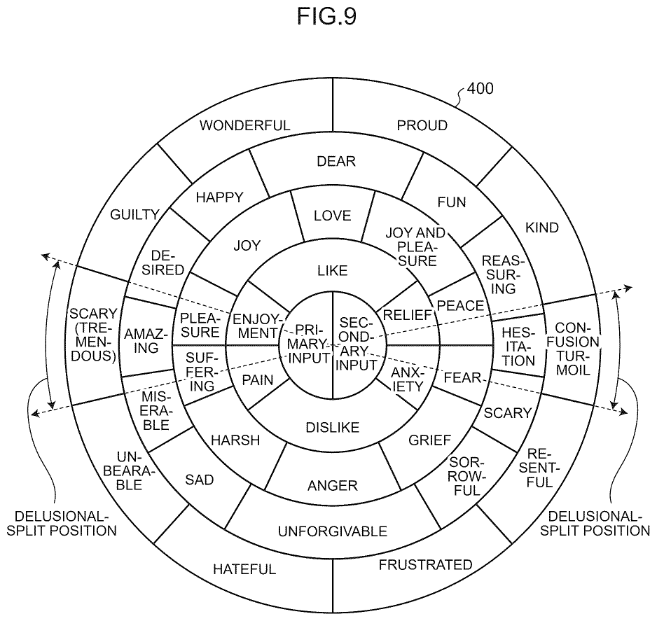

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

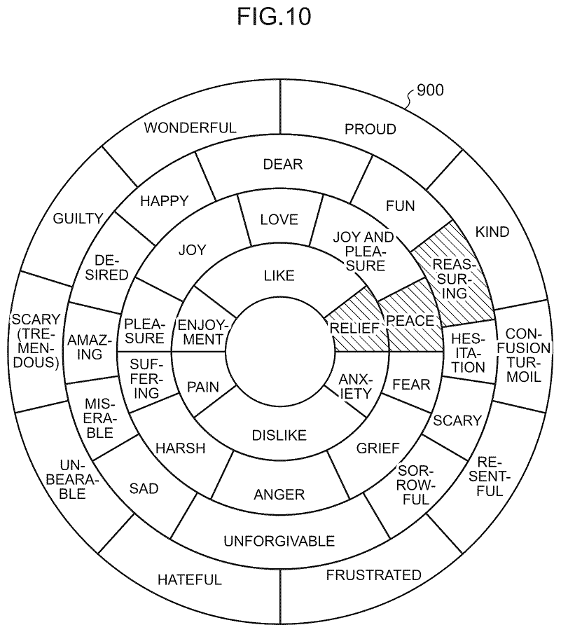

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
[Additional Note 1] A system including: a collection unit configured to collect video footage from security cameras; a detection unit configured to analyze the video footage collected by the collection unit and detect suspicious persons; a cropping unit configured to crop only necessary portions based on the suspicious persons detected by the detection unit; and a report generation unit configured to generate a report based on the video cropped by the cropping unit.
[Additional Note 2] The system according to Additional Note 1, wherein the detection unit is configured to analyze video footage from security cameras and identify persons exhibiting abnormal behavior.
[Additional Note 3] The system according to Additional Note 1, wherein the cropping unit is configured to crop only necessary portions from the video detected by the detection unit.
[Additional Note 4] The system according to Additional Note 1, wherein the report generation unit is configured to generate a report based on the video cropped by the cropping unit.
[Additional Note 5] The system according to Additional Note 1, wherein the collection unit is configured to collect video footage from a plurality of security cameras.
[Additional Note 6] The system according to Additional Note 1, wherein the detection unit is configured to detect behaviors such as picking up a product and immediately putting it back, or walking around the store unnaturally.
[Additional Note 7] The system according to Additional Note 1, wherein the collection unit is configured to estimate a user's emotion and adjust the timing of collecting video footage from security cameras based on the estimated emotion of the user.
[Additional Note 8] The system according to Additional Note 1, wherein the collection unit is configured to dynamically adjust the installation position of security cameras to perform optimal video collection.
[Additional Note 9] The system according to Additional Note 1, wherein the collection unit is configured to change the collection method during video collection based on specific time periods or days of the week.
[Additional Note 10] The system according to Additional Note 1, wherein the collection unit is configured to estimate a user's emotion and determine the priority of video to be collected based on the estimated emotion of the user.
[Additional Note 11] The system according to Additional Note 1, wherein the collection unit is configured to adjust the collection method during video collection based on weather or lighting conditions.
[Additional Note 12] The system according to Additional Note 1, wherein the collection unit is configured to analyze the congestion status in the store during video collection and select the optimal collection method.
[Additional Note 13] The system according to Additional Note 1, wherein the detection unit is configured to estimate a user's emotion and adjust the criteria for detecting abnormal behavior based on the estimated emotion of the user.
[Additional Note 14] The system according to Additional Note 1, wherein the detection unit is configured to optimize the detection algorithm during detection based on past shoplifting data.
[Additional Note 15] The system according to Additional Note 1, wherein the detection unit is configured to identify abnormal behavior during detection based on attribute information of a person.
[Additional Note 16] The system according to Additional Note 1, wherein the detection unit is configured to estimate a user's emotion and adjust the display method of detection results based on the estimated emotion of the user.
[Additional Note 17] The system according to Additional Note 1, wherein the detection unit is configured to identify abnormal behavior during detection based on store layout information.
[Additional Note 18] The system according to Additional Note 1, wherein the detection unit is configured to identify abnormal behavior during detection in cooperation with other security systems.
[Additional Note 19] The system according to Additional Note 1, wherein the cropping unit is configured to estimate a user's emotion and adjust the cropping range based on the estimated emotion of the user.
[Additional Note 20] The system according to Additional Note 1, wherein the cropping unit is configured to optimize video quality during cropping and extract necessary portions.
[Additional Note 21] The system according to Additional Note 1, wherein the cropping unit is configured to integrate multiple camera videos during cropping to perform optimal cropping.
[Additional Note 22] The system according to Additional Note 1, wherein the cropping unit is configured to estimate a user's emotion and adjust the display method of cropped video based on the estimated emotion of the user.
[Additional Note 23] The system according to Additional Note 1, wherein the cropping unit is configured to adjust the video timeline during cropping and extract optimal portions.
[Additional Note 24] The system according to Additional Note 1, wherein the cropping unit is configured to analyze audio data of the video during cropping and extract necessary portions.
[Additional Note 25] The system according to Additional Note 1, wherein the report generation unit is configured to estimate a user's emotion and adjust the content of the report based on the estimated emotion of the user.
[Additional Note 26] The system according to Additional Note 1, wherein the report generation unit is configured to select the optimal report format during report generation based on past report data.
[Additional Note 27] The system according to Additional Note 1, wherein the report generation unit is configured to automatically add video metadata during report generation.
[Additional Note 28] The system according to Additional Note 1, wherein the report generation unit is configured to estimate a user's emotion and determine the priority of the report based on the estimated emotion of the user.
[Additional Note 29] The system according to Additional Note 1, wherein the report generation unit is configured to integrate data from other security systems during report generation and generate a report.
[Additional Note 30] The system according to Additional Note 1, wherein the report generation unit is configured to select a report transmission method during report generation.

What is claimed is:

1. A system comprising: a collection unit configured to collect video footage from security cameras; a detection unit configured to analyze the video footage collected by the collection unit and detect suspicious persons; a cropping unit configured to crop only necessary portions based on the suspicious persons detected by the detection unit; and a report generation unit configured to generate a report based on the video cropped by the cropping unit.

2. The system according to claim 1, wherein the detection unit is configured to analyze video footage from security cameras and identify persons exhibiting abnormal behavior.

3. The system according to claim 1, wherein the cropping unit is configured to crop only necessary portions from the video detected by the detection unit.

4. The system according to claim 1, wherein the report generation unit is configured to generate a report based on the video cropped by the cropping unit.

5. The system according to claim 1, wherein the collection unit is configured to collect video footage from a plurality of security cameras.

6. The system according to claim 1, wherein the detection unit is configured to detect behaviors such as picking up a product and immediately putting it back, or walking around the store unnaturally.

7. The system according to claim 1, wherein the collection unit is configured to estimate a user's emotion and adjust the timing of collecting video footage from security cameras based on the estimated emotion of the user.

8. The system according to claim 1, wherein the collection unit is configured to dynamically adjust the installation position of security cameras to perform optimal video collection.
